(19) United States
(12) Patent Application Publication
(10) Pub. No.: US 2002/0098763 A1
(43) Pub. Date: Jul. 25, 2002

(54) Polishing and cleaning sheet for hard surfaces

(76) Inventors: Masashi Yoshikawa, Wakayama-shi (JP); Masashi Shioji, Wakayama-shi (JP); Kenji Ishikawa, Haga-gun (JP); Yutaka Saito, Haga-gun (JP); Michio Yokosuka, Wakayama-shi (JP)

Correspondence Address: BIRCH STEWART KOLASCH & BIRCH, PO BOX 747, FALLS CHURCH, VA, 22040-0747, US

(21) Appl. No.: 09/988,056

(22) Filed: Nov. 16, 2001

(30) Foreign Application Priority Data
Nov. 17, 2000 (JP) 2000-351332
Jan. 24, 2001 (JP) 2001-15494

(51) Int. Cl. B32B 3/00; B32B 5/02; B32B 9/00; B32B 5/22; D04H 1/00; D04H 5/00; B32B 5/26

(52) U.S. Cl. 442/340; 442/59; 428/903; 442/346; 442/76; 442/79

(57) ABSTRACT

A polishing and cleaning sheet for hard surfaces which comprises a sheet substrate impregnated with a polishing cleaner, wherein the substrate is a laminate comprising (A) a fiber aggregate comprising 50 to 100% by weight of ultrafine fibers having a fineness of 0.01 to 1.2 dtex and (B) a flexible material comprising 50 to 100% by weight of hydrophobic fibers and has a maximum absorption capacity of 4 to 15 times its own weight, the substrate is impregnated with 1 to 5 parts by weight, per part by weight of the substrate, of the polishing cleaner, provided that the amount of the polishing cleaner infiltrated in the substrate is not exceed 80% of the maximum absorption capacity, and the polishing cleaner comprises 0.01 to 10% by weight of a water-repellent compound and 50 to 99% by weight of water.

### BACKGROUND OF THE INVENTION

1. Field of the Invention

The present invention relates to a polishing and cleaning sheet which is used to wipe dirt off hard surfaces, particularly plastics, glass, coated surfaces of automobiles, metals, flooring, furniture, appliances, and the like, gives a satisfactory dirt wiping property, water repellency and a polish to the hard surfaces at a time, prevents solid particles of dirt wiped up from scratching the surface being cleaned, and has satisfactory cleaning workability.

2. Description of the Related Art

Wax is applied to hard surfaces such as flooring and car bodies to protect against staining and to beautify, but waxing needs a lot of labor and time. Waxing a car body, in particular, involves a series of work such as removing dust or dirt with a car cleaner, etc., rinsing with water, wiping dry, applying a natural or synthetic wax, drying, and rubbing out. An easier method of giving a good polish or shine to such hard surfaces has been awaited.

JP-A-62-47331 and JP-A-11-152462 disclose a polishing cloth containing wax or silicone as a convenient tool for doing such work. The teachings present a method of wiping a hard surface with a cloth impregnated with wax components or cleansing components. In wiping a hard surface with this type of cloth as held by one's hand, the cloth itself should be thick enough or large enough to be folded to make it bulky, which leads to an increased cost. The cloth disclosed is liable to be gathered, or when used as folded, the upper cloth is apt to slide on the lower one. In other words, the cloth has inconvenience to use (the convenience in cleaning will hereinafter be referred to as cleaning workability). Further, when the cloth is used to directly wipe up solid particulate dirt from a hard surface without previous washing with water, etc., the solid particulate dirt caught on the surface of fibers constituting the cloth tends to be dragged under to scratch the hard surface.

JP-A-2000-336580 discloses a water repellency-imparting cloth containing trimethyl siloxi silicate and a trimethyl siloxi silicate derivative having a hydroxyl group. JP-A-2000-256969 teaches a water repellency-supply cloth impregnated with a treating agent comprising an emulsified water-repelling component. JP-A-2000-351961 describes a cleaning, waterproofing and polishing wet cloth comprising a laminate sheet substrate composed of nonwoven fabric (base A) fabricated of hydrophilic fiber and lipophilic fiber at a ratio of 80/20 to 50/50 and a base B fabricated solely of hydrophobic fiber, the laminate sheet substrate being impregnated with an emulsified water-repellent component. Each of these techniques relating to a water repellency-imparting and polishing sheet lacks sufficient bulkiness fit for a wiping operation and for providing a uniform finish to a hard substance to be treated.

It is known to use cloth, etc. as a substrate to be impregnated with a cleaner in cleaning window glass, etc. For example, Applicant discloses in P-A-10-165344 and JP-A-11-343500 sheets having excellent cleaning performance which comprise nonwoven fabric of a specific fiber. When the sheets disclosed are impregnated with a commonly known polish in a known manner, they are not fit for use as a polishing and cleaning sheet for hard surfaces in terms of the above-described bulkiness and non-scratching properties. Polishing and cleaning compositions containing silicone are found in JP-A-50-157288, JP-A-58-65777, JP-A-4-363375, and JP-A-9-157546. Sheet substrates comprising ultrafine fibers for use as a wiping tool are found in JP-A-3-227442, JP-A-4-295325, JP-A-5-15481, and JP-A-5-93350. None of these publications has a mention of a polishing and cleaning sheet for hard surfaces that is convenient to use and causes little damage to a surface being cleaned.

### SUMMARY OF THE INVENTION

An object of the present invention is to provide a polishing and cleaning sheet which exhibits satisfactory dirt wiping performance on hard surfaces, particularly plastics, glass, coated surfaces of automobiles, metals, flooring, furniture, appliances, and the like, gives water repellency and a polish to the hard surfaces at a time, prevents solid particles of dirt wiped up from scratching the surface to be cleaned, and has satisfactory cleaning workability.

The present invention provides a polishing and cleaning sheet for hard surfaces which comprises a sheet substrate impregnated with a polishing cleaner, wherein the sheet substrate is a laminate comprising (A) a fiber aggregate comprising 50 to 100% by weight of ultrafine fibers having a fineness of 0.01 to 1.2 dtex and (B) a flexible material comprising 50 to 100% by weight of hydrophobic fibers and has a maximum absorption capacity of 4 to 15 times its own weight, the sheet substrate is impregnated with 1 to 5 parts by weight of the polishing cleaner per part by weight of the sheet substrate, provided that the amount of the polishing cleaner infiltrated in the sheet substrate is not exceed 80% of the maximum absorption capacity, and the polishing cleaner comprises 0.01 to 10% by weight of a water-repellent compound and 50 to 99% by weight of water.

The term “maximum absorption capacity” as used herein means one expressed in part by weight per part by weight of the sheet substrate as measured by the method and with the apparatus as specified in JIS K6550, except for replacing distilled water with a polishing cleaner used in the present invention. The term “hydrophobic fiber” as used herein denotes fiber having an official regain of 5% or less.

The polishing and cleaning sheet for hard surfaces according to the present invention shows satisfactory dirt wiping properties on a hard surface while giving water repellency and a polish to the hard surface simultaneously, prevents solid particles of dirt wiped up from scratching the surface to be cleaned, and has satisfactory cleaning workability.

### DETAILED DESCRIPTION OF THE PREFERRED EMBODIMENTS

The sheet substrate which can be used in the present invention is a laminate of (A) a fiber aggregate comprising 50 to 100% by weight of ultrafine fibers having a fineness of 0.01 to 1.2 dtex (the ultrafine fiber will hereinafter be also referred to as fiber A-1, and the fiber aggregate will hereinafter be referred to as base A) and (B) a flexible material comprising 50 to 100% by weight of hydrophobic fibers (hereinafter referred to as a base B).

The term “sheet substrate” or simply “substrate” as used herein is used to describe a substrate not containing a polishing cleaner. The term “fiber aggregate” indicates an aggregate of a plurality of single strands shaped into a structure by entanglement or partial thermal fusion.

The ultrafine fiber (fiber A-1) which constitutes the base A is described in The Society of Fiber Science and Technology, Japan (ed.), Sen-i Binran, 2nd ed., pp. 49-51, Maruzen Co., Ltd. (1994). It is prepared by mutually arranged polymer structure (sea-island structure) fiberising, peel type conjugate spinning, modified traditional spinning, weight loss treatment, superdrawing, melt-blowing, flash spinning, beating, mixed spinning, tack spinning, foam sheeting, centrifugal spinning or composition modification.

Dividable fibers prepared by peel type conjugate spinning are preferably used to obtain the fiber A-1. The dividable fibers are divided by a mechanical force, pressure, etc. into a plurality of ultrafine fibers having irregular cross-sections, which have increased adhesion to a hard surface being cleaned and thereby exhibit improved ability to collect particulate dirt. From the standpoint of cleaning workability and reduced scratching properties on a hard surface, 6- to 20-dividable fibers, particularly 6- to 10-dividable fibers, especially 8-dividable fibers are desirable.

In order to obtain particulate dirt-collecting properties and to reduce scratches on hard surfaces by solid particulate dirt, the fibers (A-1) have a fineness of 0.01 to 1.2 dtex, preferably 0.01 to 0.9 dtex.

The length of the fibers (A-1) is not particularly limited. Long fiber filaments and staple fibers can be used. Staple fibers having a length of 20 to 110 mm are preferred.

From the aspect of material, the fiber (A-1) includes polyolefin fibers, such as polypropylene fiber and polyethylene fiber, polyester fiber, polyamide fiber, acrylic fiber, polyvinyl chloride fiber, and conjugate fibers made of these fibers. In the invention, dividable fibers made of a combination of polypropylene fiber and polyethylene fiber, a combination of polyester fiber and polyethylene fiber, a combination of polyester fiber and polypropylene fiber, or a combination of polyamide fiber and polyester fiber are preferred. Dividable conjugate fibers made of a combination of polyester fiber and polyethylene fiber or a combination of polyester fiber and polypropylene fiber and having a daisy-like cross-section are preferred for particulate dirt-collecting properties and reduced scratching by solid particulate dirt.

It is preferred for cleaning workability that the base A comprises, in addition to the fiber A-1, at least one kind of other fibers selected from polyolefin fibers such as polypropylene fiber and polyethylene fiber, polyester fiber, polyamide fiber, acrylic fiber, polyvinyl chloride fiber and conjugate fibers thereof (e.g., core-sheath type conjugate fiber or side-by-side type conjugate fiber), polyurethane fiber, polyester fiber having been made hydrophilic, polyvinyl alcohol fiber, rayon, cotton, and pulp (hereinafter referred to as fiber A-2). The fiber A-2 is preferably selected from acrylic fiber, polyamide fiber, and polyester fiber having been made hydrophilic.

It is preferred for cleaning workability and reduced scratching by solid particulate dirt that the fibers A-2 have a fineness of 0.8 to 10 dtex, particularly 0.8 to 5 dtex.

The length of the fibers A-2 is not particularly limited. Long fiber filaments and staple fibers can be used. Staple fibers having a length of 20 to 110 mm are preferred.

For cleaning workability and reduced scratching by solid particulate dirt, a preferred mixing ratio of the fibers A-1 to A-2 is 50/50 or higher, particularly 60/40 to 90/10.

For particulate dirt-collecting property and reduced scratching by solid particulate dirt, the base A preferably has a basis weight of 5 to 200 g/m², particularly 15to 100 g/m².

The base B is a flexible material comprising 50 to 100% by weight of hydrophobic fibers. The form of the base B includes sponge, nonwoven fabric, woven fabric, and a laminate of fiber webs prepared by carding or a like method. Nonwoven fabric is preferred for capability of retaining a polishing cleaner, making the substrate feel bulky, and improving the cleaning workability. Suitable nonwoven fabrics includes thermal bonded (air-through) nonwoven fabric, spun-laced nonwoven fabric, and air-laid nonwoven fabric.

The hydrophobic fiber which can be used in the present invention is fiber having an official regain of 5% or less. To produce a bulky feel (bulkiness), the base B has a hydrophobic fiber content of 50 to 100%, preferably 70 to 100%, by weight. The “official regain” can be determined by the method specified in JIS L0105.

One of the important features constituting the present invention consists in that the base B contains the hydrophobic fiber at a certain ratio or above. The sheet substrates disclosed in the prior art, JP-A-11-152462, JP-A-2000-351961 and JP-A-2000-256969, which use hydrophilic nonwoven fabric as a base B, are utterly different from the substrate used in the present invention in this respect. The hydrophobic fiber includes polyolefin fibers such as polypropylene fiber and polyethylene fiber, polyester fiber, polyamide fiber, acrylic fiber, and conjugate fibers thereof (e.g., core-sheath type conjugate fiber or side-by-side type conjugate fiber). Of these fibers preferred is at least one of polypropylene fiber, polyethylene fiber, and polyester fiber. The official regain of core-sheath type conjugate fiber is the one measured on the sheath. The hydrophobic fibers are preferably crimped in three dimensions to increase the thickness or bulkiness of the base B. Where the laminate of the bases A and B is subjected to a heat treatment to form surface unevenness, thermally shrinking fibers or thermally self-crimping fibers are used.

The hydrophobic fibers preferably have a fineness of 0.8 to 20 dtex, particularly 0.8 to 10 dtex, to give bulkiness.

The length of the hydrophobic fibers is not particularly limited. Long fiber filaments and staple fibers can be used. Staple fibers having a length of 20 to 110 mm are preferred.

The base B may further comprise hydrophilic fiber, such as polyester fiber having been rendered hydrophilic, polyvinyl alcohol fiber, rayon, cotton, and pulp.

Taking into consideration the bulkiness of the laminate substrate, cleaning workability and cost, the base B preferably has a basis weight of 5 to 200 g/m², particularly 15 to 100 g/m².

Where the base B is nonwoven fabric, it is preferably joined to the base A through water jet needling or thermal fusion. The sheet substrate can have a multilayer structure composed of three or more layers of the bases A and B. In this case, it is important that the side that is to be brought into contact with a hard surface to be cleaned should be entirely or substantially formed of the base A. The most preferred sheet substrate is a three-layer structure having the base B interposed between a pair of bases A.

The sheet substrate composed of the bases A and B preferably has a basis weight of 10 to 300 g/m², particularly 30 to 150 g/m².

The sheet substrate having the above-mentioned structure is, upon being impregnated with a polishing cleaner to a specific pickup as hereinafter described, capable of providing a polishing cleaning sheet which does not release the cleaner too much while in use and equally keeps performing the cleaning and polishing functions to the last.

In the best mode of the present invention, the sheet substrate has a three-layer structure composed of a pair of the bases A shown in Table 1 having the base B shown below interposed therebetween and has a basis weight of 30 to 150 g/m².

TABLE 1

| | | Basis | | |
|---|---|---|---|---|
| | | Weight | | Fineness |
| Base | Form | (g/m²⁾ | Constituent Fiber | (dtex) |
| A | non- | 15-100 | 60/40 to 100/0 union fiber of | (A-1): |
| | woven | | (A-1) divided ultrafine fiber of | 0.01-0.9 |
| | fiber | | polyester fiber and polyethylene | (A-2): |
| | | | fiber and (A-2) acrylic fiber | 0.8-5 |
| B | non- | 15-100 | at least one hydrophobic fiber | 0.8-10 |
| | woven | | selected from polypropylene fiber, | |
| | fiber | | polyethylene fiber, | |
| | | | and polyester fiber | |

The polishing and cleaning sheet of the present invention is obtained by impregnating the above-described sheet substrate with a liquid polishing cleaner. The maximum absorption capacity of the sheet substrate when impregnated with the liquid polishing cleaner is 4 to 15 parts, preferably 5 to 10 parts, per part by weight of the sheet substrate. The sheet substrate is impregnated with the polishing cleaner to a pickup of 1 to 5 parts, preferably 1 to 3.5 parts, by weight per part by weight of the dry sheet substrate. The pickup should not exceed 80% of the maximum absorption capacity. A preferred pickup is in a range of from 20 to 70% of the maximum absorption capacity. In order to obtain sufficient polishing and cleaning effects on hard surfaces, the sheet substrate should have a maximum absorption capacity falling within the above-specified range. In order to remove effectively solid dirt particles without causing the particles to scratch hard surfaces while being cleaned, the pickup should be within the above-specified percentage based on the maximum absorption capacity.

In carrying out polishing and cleaning with the polishing and cleaning sheet of the present invention, the base A side having the ultrafine fibers is applied to a hard surface to be treated under a wiping load. Whereupon, an appropriate amount of the polishing cleaner oozes to fill the gap between the base A and the hard surface and helps the ultrafine fibers catch up fine solid particles of dirt to exert sufficient wiping effects while preventing the dirt particles from scratching the hard surface. Too large or too small a pickup can not only interfere with the ultrafine fibers in catching solid dirt but cause an uneven polish.

The sheet impregnated with a polishing cleaner preferably has an average thickness of 500 to 5000 μm, particularly 500 to 3000 μm.

It is desirable that the polishing cleaner be substantially present in the base B more than in the base A.

The liquid polishing cleaner with which the sheet substrate is impregnated comprises 0.01 to 10%, preferably 0.05 to 5%, still preferably 0.1 to 2%, by weight of a water-repellent compound and 50 to 99.9%, preferably 90 to 99.9%, by weight of water.

A water-repellent compound content of the polishing cleaner less than 0.01% by weight fails to impart sufficient water repellency and a polish to a hard surface. A water-repellent compound content more than 10% by weight leaves the excess of the compound on a hard surface, resulting in reduced dirt wiping effects and an uneven finish or polish. If the water content is less than 50% by weight, cleaning performance on hydrophilic solid particles, such as soil or sand, is reduced. If it is more than 99.9% by weight, the sheet fails to impart sufficient water repellency and a polish to hard surfaces.

A silicone emulsion is a preferred water-repellent compound from the standpoint of water repellency, shine, and cleaning workability. Fluororesins commonly employed as a water-repellent compound are also usable.

Silicone is an organopolysiloxane oil, including straight silicones, such as dimethylpolysiloxane oil (hereinafter called “dimethyl silicone”), phenylmethylpolysiloxane (dimethyl silicone with part of the methyl groups replaced with phenyl groups), methylhydrogenpolysiloxane (dimethyl silicone with part of the methyl groups replaced with hydrogen atoms), and dimethylpolysiloxanediol carrying a reactive silanol group at both terminals; and other organopolysiloxane oils having at least one kind of organic groups other than a methyl group replacing part of the methyl groups of these straight silicones (hereinafter called “modified silicones”). Examples of the modified silicones are given in Kunio Itoh (ed.), Silicone Handbook 1st Ed., Ch. 6, The Nikkan Kogyo Shimbun, Ltd. (1990). The organic groups other than a methyl group include amino-containing organic groups, amido-containing organic groups, polyether-containing organic groups, epoxy-containing organic groups, carboxyl-containing organic groups, alkyl-containing organic groups, alkoxy-containing organic groups, fluoroalkyl-containing organic groups, and carbinol-containing organic groups. In the present invention, modified silicones having an amino-containing organic group (hereinafter called “amino-modified silicones”) are preferred. Amino-modified silicones represented by formula (I) shown below are particularly preferred.

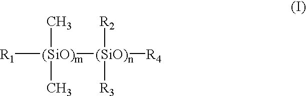

wherein one or more of R₁, R₂, R₃ and R₄ represent(s) an organic group represented by —R₅NH₂, —R₆NHR₇N₂ or —R₈NH- [symbol] (wherein R₅, R₆, R₇, and R₈, which may be the same or different, each represent an alkylene group having 2 to 4 carbon atoms), the rest representing a hydrogen atom, a silanol group or a straight-chain or branched alkyl group having 1 to 100 carbon atoms; and m and n each represent an integer of 1 to 5000.

Where these silicone compounds are added to the polishing cleaner, they can be used either individually or as a combination of two or more thereof. In the present invention it is preferred to use an amino-modified silicone in combination with dimethyl silicone, a modified silicone having a polyether-containing organic group or a modified silicone having an alkoxy-containing organic group in view of cleaning performance and polish.

Where an amino-modified silicone is used as a water-repellent compound, it preferably has an amino equivalent of 500 to 50,000 g/mol, particularly 500 to 20,000 g/mol, especially 1,000 to 20,000 g/mol.

The silicone compound is preferably used in the form of an oil-in-water emulsion, in which a surface active agent is preferably used as an emulsifier. Preferred surface active agents include anionic ones, such as alkylbenzenesulfonic acids and salts thereof, alkylsulfuric ester salts, polyoxyalkylene alkyl ether sulfates, olefinesulfonic acid salts, alkanesulfonic acid salts, and fatty acid salts; nonionic ones, such as polyoxyalkylene alkyl or alkenyl ethers, polyoxyalkylene alkylphenyl ethers, fatty acid alkanolamides or alkylene oxide adducts thereof, sucrose fatty acid esters, sorbitan fatty acid esters, fatty acid glycerides, alkyl glucosides, and alkyl glycerol ethers; amphoteric ones, such as amine oxides, sulfobetaines, and carbobetaines; cationic ones, such as mono(long-chain alkyl) quaternary ammonium salts, di(long-chain alkyl) quaternary ammonium salts, and tri(long-chain alkyl) quaternary ammonium salts; and silicone ones, such as polyether-modified silicone.

Particularly preferred surface active agents for use in the present invention are alkylbenzenesulfonic acids and salts thereof, alkylsulfuric ester salts, polyoxyalkylene alkyl ether sulfates, polyoxyalkylene alkyl or alkenyl ethers, polyoxyalkylene alkylphenyl ethers, sucrose fatty acid esters, sorbitan fatty acid esters, fatty acid glycerides, alkyl glucosides, alkyl glycerol ethers, mono(long-chain alkyl) quaternary ammonium salts, and di(long-chain alkyl) quaternary ammonium salts.

The surface active agent is preferably used at a weight ratio to the silicone of 1/1000 to 2/1, particularly 5/1000 to 1/1, especially 1/100 to 1/1, from the viewpoint of emulsifying properties and cleaning performance. The emulsified particles preferably have an average particle size of 0.01 to 30 μm, particularly 0.01 to 5 μm, in view of cleaning performance and stability.

Where an amino-modified silicone is used as a water-repellent compound, it is preferred for the polishing cleaner to contain an organic acid having at least one carboxyl group or a salt thereof, particularly one having 3 to 7 carbon atoms.

The amino-modified silicone tends to cause yellowing of the sheet with time due to susceptibility of its aminoalkyl group to oxidation under heat or when exposed to ultraviolet light. To suppress yellowing sufficiently, it is effective to adjust the pH of the polishing cleaner to 7.0 or lower. For the same purpose, it is more effective to use the amino-modified silicone in combination with an organic acid having at least one carboxyl group or a salt thereof. The organic acid having a carboxyl group is preferably used in an amount of 0.1 to 10 mol, particularly 0.3 to 5 mol, in terms of total carboxyl group content, per mole of total amino group content of the amino-modified silicone. The lower limit of the carboxyl group content of o. 1 mol is for producing a substantial inhibitory effect on yellowing, and the upper limit of 10 mol is for suppressing finish unevenness or glare.

Suitable organic acids include lactic acid, gluconic acid, succinic acid, glutaric acid, adipic acid, malic acid, tartaric acid, maleic acid, fumaric acid, itaconic acid, citric acid, benzoic acid, salicylic acid, and salts of these carboxylic acids; amino acids such as glycine, alanine, valine, leucine, serine, glutamic acid, and aspartic acid, and salts thereof. Preferred of them are lactic acid, succinic acid, malic acid, tartaric acid, citric acid, and benzoic acid, and salts of these acids.

The polishing cleaner is preferably adjusted to a pH 3 to 7, particularly 4 to 6. Cleaners having a pH lower than 3 can cause skin roughening and damage to the surfaces to be cleaned. Cleaners having a pH higher than 7 lack a sufficient inhibitory effect on yellowing. Adjustment of pH is preferably effected with the above-recited organic acids.

The polishing cleaner preferably contains a terpene compound to sufficiently suppress non-uniformity in shine even under such conditions that the hard surface to be cleaned has an elevated temperature, for example in the summer heat. Terpene compounds preferred for this purpose include monoterpene compounds, such as α-pinene, β-pinene, camphene, limonene, dipentene, terpinolene, myrcene, linalool, geraniol, nerol, citronellol, hydroxycitronellol, tetrahydrolinalool, myrcenol, terpineol, menthol, borneol, and isopulegol. The terpene compound is preferably used in an amount of 0.01 to 2%, particularly 0.02 to 1%, especially 0.05 to 1%, by weight based on the polishing cleaner.

For the purpose of improving the cleaning effect or stabilizing the liquid phase of the polishing cleaner, a water-soluble solvent is preferably added. Suitable water-soluble solvents include 1,3-dimethyl-2-imidazolidinone, 1,3-diethyl-2-imidazolidinone, ethanol, isopropyl alcohol, propylene glycol, polyoxyethylene phenyl (or benzyl) ether (ethylene oxide mole number added: 1 to 5), ethylene glycol monomethyl ether, and propylene glycol monomethyl ether. Ethanol, isopropyl alcohol, propylene glycol, and propylene glycol monomethyl ether are particularly preferred. The water-soluble solvent is suitably added in an amount of 0.1 to 20%, particularly 0.5 to 10%, by weight based on the polishing cleaner.

If desired, the polishing cleaner can contain additives customarily used in cleaners, such as sequestering agents (particularly those described in column 3, line 49 to column 4, line 24 of JP-A-7-233394), thickeners, colorants, perfumes, antimicrobials, and antiseptics; wax components; alkali agents; and water-insoluble or sparingly water-soluble solid particles described in claim 4 of JP-A-10-287900. Perfume components other than the above-described terpene compounds can be added to the polishing cleaner, but the content of such components, if added, is desirably up to 0.1% by weight based on the polishing cleaner so as not to ruin the effect of the terpene compound. Where these additives are used, they are desirably up to 5% by weight based on the polish cleaner.

A preferred formulation of the polishing cleaner used in the present
invention is shown below. The percents are by weight.

| Preferred Formulation: | |
|---|---|
| Amino-modified silicone | 0.1 to 2% |
| Dimethyl silicone | 0 to 0.5% |
| Surface active agent comprising | 0.01 to 0.5% |
| polyoxyethylene alkyl ether | |
| Ethanol and/or isopropyl alcohol | 0.5 to 10% |
| Citric acid, malic acid and/or succinic acid | adequate amount to |
| | adjust to pH 4.0 to 6.0 |
| Terpene compound | 0.05 to 0.2% |
| Perfumes other than terpene compound | 0 to 0.1% |
| Antiseptic | 0 to 0.5% |
| Ion-exchanged water | balance |
| Total | 100% |

If the polishing cleaner pickup is less than 1 part by weight per part by weight of the sheet substrate, sufficient cleaning performance is not exhibited. If it exceeds 5 parts by weight, the polishing cleaner will be released too much on a hard surface being cleaned, and dirt remains on the hard surface after wiping. Further, too much cleaner needs time to dry.

The present invention will now be illustrated in greater detail by way of Examples. Unless otherwise noted, all the percents, parts, and ratios are given by weight.

### EXAMPLE 1

Preparation of Substrates:

1) Substrate 1

Low-melting and three-dimensionally self-crimping core-sheath type conjugate fibers having a polypropylene core and a polyethylene sheath (fineness: 2.8 dtex; length: 51 mm; sheath melting point: 130° C.) were thermally fused together at 140° C. to form thermally bonded (air-through) nonwoven fabric having a basis weight of 30 g/m² as a base B.

Eight-dividable fibers of daisy type having a fineness of 3.3 dtex and a length of 51 mm composed of polyester fiber and polyethylene fiber (average fineness after division: 0.42 dtex) were mixed with acrylic fiber (fineness: 0.9 dtex; length: 51 mm) at a ratio of 70:30, and the mixed fiber was carded by means of a conventional card to prepare a fiber web having a basis weight of 27 g/m² as a base A. The base A was superposed on each side of the base B and entangled with the base B by water needling to prepare a laminate, designated substrate 1, having an area of 300 mm by 300 mm, a basis weight of 84 g/m², and a thickness of 1100 μm. The thickness ratio of the two bases A to the base B was 5/5.

2) Substrate 2

Substrate 2 was prepared in the same manner as for substrate 1, except that acrylic fiber was not used in the base A. Substrate 2 had an area of 300 mm by 300 mm, a basis weight of 75 g/m², and a thickness of 900 μm. The thickness ratio of the two bases A to the base B was 5/5.

3) Substrate 3

Spun-laced nonwoven fabric (area: 300 mm by 300 mm; basis weight: 84 g/m²; thickness: 800 μm) made of rayon (1.7 dtex, 40 mm long) by water needling.

4) Substrate 4

Cotton towel (area: 300 mm by 300 mm; basis weight: 300 g/m²; thickness: 3000 μm)

Preparation of Polishing Cleaners:

Polishing cleaners were prepared according to the formulations shown in Table 2 below. Particulars of the materials (a) to (c) used in the formulations are as follows.

(a) Amino-modified Silicone

A mixture of 30% of an amino-modified silicone BY16-850 (amino equivalent: 4000; viscosity: 1100 mm²/sec; available from Dow Corning Toray Silicone Co., Ltd.) and 10% of a lauryl alcohol-ethylene oxide (6 mol) adduct as a nonionic surface active agent, the balance being water, was emulsified in a homomixer. The average emulsified particle size was 0.1 μm. The amount shown in Table 2 is based on the weight of BY16-850.

(b) Dimethyl Silicone

Dimethyl silicone SH200-50cs (viscosity: 50 mm²/sec; available from Dow Corning Toray Silicone Co., Ltd.).

(c) Antiseptic

Methyl p-hydroxybenzoate.

Method for Performance Evaluation:

A plate (1000 mm by 1000 mm) having a coat with a black metallic luster equated with a plate actually used in a car body was left to stand outdoors for three weeks to prepare a coated plate on which soil dust had been accumulated.

The sheet substrate prepared above (300 mm×300 mm) was impregnated with the polishing cleaner shown in Table 2. The soiled coated plate was wiped with the impregnated sheet folded into four. The bulkiness felt in wiping, cleaning workability and dust removal properties of the polishing cleaning sheets and the shine, water repellency and surface scratches of the wiped plate were scored by a panel of three members according to the following criteria. The scores given by the panel was averaged. Averaged scores of 1 or higher and below 2 were graded “A”, those of 2 or higher and below 3 “B”, and those of 3 or higher “C”. All the evaluation was made at room temperature. The results obtained are shown in Table 2.

i) Bulkiness

1: Sufficient bulkiness is felt.

2: Bulkiness is slightly insufficient but satisfactory.

3: Bulkiness is insufficient.

4: The sheet distinctly lacks bulkiness.

ii) Cleaning Workability

1: The sheet is not gathered nor slid during wiping.

2: The sheet is slightly gathered or slid but has no problem in wiping.

3: The sheet is slightly inconvenient to use in wiping due to gathering or sliding.

4: The sheet is inconvenient to use in wiping due to gathering or sliding.

iii) Dust Removal

1: The dust is completely removed by giving one or two wiping strokes of the sheet.

2: The dust is removed almost completely by giving one or two wiping strokes of the sheet.

3: The dust is removed to a satisfactory degree by giving three to five wiping strokes with the sheet.

4: Giving three to five wiping strokes with the sheet does not remove the dust satisfactorily.

iv) Uniformity of Shine

1: Wiping brings about a uniform shine.

2: The shine is slightly uneven but satisfactory.

3: Wiping results in an uneven shine.

4: Wiping results in a considerable uneven shine.

v) Water Repellency

1: Wiping imparts uniform water repellency.

2: Wiping imparts almost uniform water repellency.

3: Water repellency is slightly insufficient.

4: No water repellency is imparted.

vi) Non-scratching Properties

1: Wiping causes substantially no scratches.

2: Wiping causes fine scratches that might be made on a car body while running.

3: Wiping causes slight scratches.

4: Wiping causes scratches.

TABLE 2

| Sample No. | | | | |
|---|---|---|---|---|
| 1 | 2 | 3 | 4 | 5 |

Formulation of Cleaner (wt %):

| | | | | | |
|---|---|---|---|---|---|
| Amino-modified | 0.4 | 0.4 | 0.4 | 0.4 | 0.4 |
| Silicone (a) | | | | | |
| Dimethyl silicone (b) | 0.1 | | | | |
| Ethanol | 5 | 5 | 5 | 5 | 5 |
| Antiseptic (c) | 0.2 | 0.2 | 0.2 | 0.2 | 0.2 |
| Ion-exchanged water | Balance | balance | Balance | balance | balance |
| Total | 100 | 100 | 100 | 100 | 100 |
| Substrate | 1 | 2 | 3 | 1 | 4 |
| Max. absorption capacity | 7.0 | 7.0 | 5.0 | 7.0 | 6.0 |
| (part) | | | | | |
| Pickup (part/part of | 2.5 | 2.5 | 2.5 | 7.0 | 2.5 |
| substrate) | | | | | |
| Percentage of pickup to | 36 | 36 | 50 | 100 | 42 |
| max. absorption capacity | | | | | |
| (%) | | | | | |

Performance Evaluation:

| | | | | | |
|---|---|---|---|---|---|
| Bulkiness | A | A | C | A | A |
| Cleaning workability | A | B | C | A | B |
| Dust removal | A | A | C | C | C |
| Uniformity of shine | A | A | A | C | C |
| Water repellency | A | A | A | A | A |
| Non-scratching | A | A | C | A | C |
| Properties | | | | | |

### EXAMPLE 2

Polishing cleaners having the formulations shown in Table 3 were prepared. The materials (a) to (c) are the same as in Example 1. Substrate 1 prepared in Example 1 was impregnated with 2.5 parts of each polishing cleaner per part of the substrate to prepare polishing and cleaning sheets (sample Nos. 6 to 12).

Method for Performance Evaluation:

The performance properties of the resulting polishing and cleaning sheets were evaluated in the same manner as in Example 1, except that the surface temperature of the coated plate used in the evaluation of shine uniformity was kept at 60° C. on a hot plate to simulate a state under the scorching sun. The results obtained are shown in Table 3.

TABLE 3

| Sample No. | | | | | | |
|---|---|---|---|---|---|---|
| 6 | 7 | 8 | 9 | 10 | 11 | 12 |

Formulation of Cleaner (wt %)

| | | | | | | | |
|---|---|---|---|---|---|---|---|
| Amino-modified | 0.4 | 0.4 | 0.4 | 0.4 | 0.4 | 0.4 | 0.4 |
| Silicone (a) | | | | | | | |
| Dimethyl silicone (b) | 0.1 | 0.1 | 0.1 | 0.1 | 0.1 | 0.1 | 0.1 |
| α-Pinene | 0.05 | | | | | | |
| β-Pinene | | 0.05 | | | | | |
| Camphene | 0.05 | | | | | | |
| Limonene | 0.05 | 0.05 | 0.05 | 0.05 | 0.05 | | 0.5 |
| Dipentene | | | | 0.05 | | | 0.5 |
| Terpinolene | | 0.05 | | | | | |
| Myrcene | 0.05 | | | | | | |
| Linalool | | | | 0.05 | 0.05 | | 0.5 |
| Geraniol | | 0.05 | | | | | |
| Nerol | | | | 0.05 | | | 0.5 |
| Citronellol | | | | 0.05 | | | 0.5 |
| Hydroxycitronellol | 0.05 | | | | 0.05 | | |
| Tetrahydrolinalool | | | 0.05 | | | | |
| Myrcenol | | | 0.05 | | | | |
| Terpineol | 0.05 | | | | | | |
| Terpinene | | | | | | | 0.5 |
| Dihydromyrcenol | | | | | | | 0.5 |
| Lavandulol | | | | | | | 0.5 |
| Tetrahydrogeraniol | | | | | | | 0.5 |
| Menthol | | | 0.05 | | | | |
| Borneol | | 0.05 | | | | | |
| Isopulegol | | | 0.05 | | | | |
| Ethanol | 5 | 5 | 5 | 5 | 5 | 5 | 5 |
| Antiseptic (c) | 0.2 | 0.2 | 0.2 | 0.2 | 0.2 | 0.2 | 0.2 |
| Ion-exchanged water | Bal- | bal- | bal- | bal- | bal- | bal- | bal- |
| | ance | ance | ance | ance | ance | ance | ance |
| Total | 100 | 100 | 100 | 100 | 100 | 100 | 100 |
| Pickup (part/part of substrate) | 25 | 25 | 25 | 25 | 25 | 25 | 25 |

Performance Evaluation:

| | | | | | | | |
|---|---|---|---|---|---|---|---|
| Bulkiness | A | A | A | A | A | A | A |
| Cleaning workability | A | A | A | A | A | A | A |
| Dust removal | A | A | A | A | A | A | A |
| Uniformity of shine | A | A | A | A | A | B | C |
| Water repellency | A | A | A | A | A | A | A |
| Non-scratching Properties | A | A | A | A | A | A | A |

### EXAMPLE 3

Polishing cleaners having different pH values were prepared according to the formulations shown in Table 4. The materials (b) and (c) in Table 4 are the same as in Example 1. The material (d) is described below. Monoethanolamine was used in a requisite amount for the pH adjustment, which is indicated in Table 4 by the mark +.

(d) Amino-modified Silicone:

A mixture of 30% of an amino-modified silicone having the formula shown below (amino equivalent: 2000) and 10% of a lauryl alcohol-ethylene oxide (6 mol) adduct as a nonionic surface active agent, the balance being water, was emulsified in a homomixer. The average emulsified particle size was 0.1 μm.

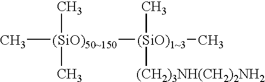

Substrate 1 prepared in Example 1 was impregnated with each of the cleaners to a pickup of 2.5 parts per part of the substrate to prepare polishing and cleaning sheets (sample Nos. 13 to 20). The resulting polishing and cleaning sheets were evaluated in the same manner as in Example 2 and additionally inspected for yellowing during storage in accordance with the following test method. The results obtained are shown in Table 4.

Method of Evaluating Yellowing:

The polishing and cleaning sheet was folded into four and packaged in a bag of an aluminum foil-laminated multilayer film having a hole 30 mm wide and 60 mm long. The bag and the contents were allowed to stand at 60° C. for 24 hours, and yellowing of the sheet occurring around the hole was scored by a panel of three members according to the following criteria. The scores given by the panel was averaged. Averaged scores of 1 or higher and below 2 were graded “A”, those of 2 or higher and below 3 “B”, and those of 3 or higher “C”. The results obtained are shown in Table 4.

Yellowing of Sheet

1: Yellowing of the sheet does not occur.

2: Very slight yellowing of the sheet occurs partially.

3: Slight yellowing occurs all over the sheet.

4: Strong yellowing occurs all over the sheet.

TABLE 4

| Sample No. | | | | | | | |
|---|---|---|---|---|---|---|---|
| 13 | 14 | 15 | 16 | 17 | 18 | 19 | 20 |

Formulation of Cleaner (wt %):

| | | | | | | | | |
|---|---|---|---|---|---|---|---|---|
| Amino-modified | 0.4 | 0.4 | 0.4 | 0.4 | 0.4 | 0.4 | 0.4 | 0.4 |
| Silicone (d) | | | | | | | | |
| Dimethyl silicone | 0.1 | 0.1 | 0.1 | 0.1 | 0.1 | 0.1 | 0.1 | 0.1 |
| (b) | | | | | | | | |
| α-Pinene | 0.05 | 0.05 | 0.05 | 0.05 | 0.05 | 0.05 | 0.05 | 0.05 |
| Camphene | 0.05 | 0.05 | 0.05 | 0.05 | 0.05 | 0.05 | 0.05 | 0.05 |
| Limonene | 0.05 | 0.05 | 0.05 | 0.05 | 0.05 | 0.05 | 0.05 | 0.05 |
| Myrcene | 0.05 | 0.05 | 0.05 | 0.05 | 0.05 | 0.05 | 0.05 | 0.05 |
| Hydroxycitronellol | 0.05 | 0.05 | 0.05 | 0.05 | 0.05 | 0.05 | 0.05 | 0.05 |
| Terpineol | 0.05 | 0.05 | 0.05 | 0.05 | 0.05 | 0.05 | 0.05 | 0.05 |
| Ethanol | 5 | 5 | 5 | 5 | 5 | 5 | 5 | 5 |
| Antiseptic (c) | 0.2 | 0.2 | 0.2 | 0.2 | 0.2 | 0.2 | 0.2 | 0.2 |
| Citric acid | 0 | 0.01 | 0.01 | 0.01 | 0.01 | 0.01 | 0.001 | 0.14 |
| Monoethanolamine | 0 | 0 | + | + | + | + | + | + |
| Ion-exchanged water | bal- | bal- | bal- | bal- | bal- | bal- | bal- | bal- |
| | ance | ance | ance | ance | ance | ance | ance | ance |
| Total | 100 | 100 | 100 | 100 | 100 | 100 | 100 | 100 |
| PH | 6.0 | 4.3 | 5.0 | 6.0 | 7.0 | 8.0 | 5.7 | 4.3 |
| Total carboxyl content | 0 | 0.78 | 0.78 | 0.78 | 0.78 | 0.78 | 0.078 | 11 |
| (mol/mol-total amino content) | | | | | | | | |
| Pickup (part/part of substrate) | 2.5 | 2.5 | 2.5 | 2.5 | 2.5 | 2.5 | 2.5 | 2.5 |

Performance Evaluation:

| | | | | | | | | |
|---|---|---|---|---|---|---|---|---|
| Bulkiness | A | A | A | A | A | A | A | A |
| Cleaning workability | A | A | A | A | A | A | A | A |
| Dust removal | A | A | A | A | A | A | A | A |
| Shine uniformity | A | A | A | A | A | A | A | C |
| Water repellency | A | A | A | A | B | C | A | A |
| Non-scratching | A | A | A | A | A | A | A | A |
| Properties | | | | | | | | |
| Yellowing resistance | C | A | A | A | B | C | C | A |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

This application claims the priority of Japanese Patent Application Nos. 2000-351332 filed Nov. 17, 2000 and 2001-15494 filed Jan. 24, 2001, which are incorporated herein by reference.

What is claimed is:

1. A polishing and cleaning sheet for hard surfaces which comprises a sheet substrate impregnated with a polishing cleaner, wherein said sheet substrate is a laminate comprising (A) a fiber aggregate comprising 50 to 100% by weight of ultrafine fibers having a fineness of 0.01 to 1.2 dtex and (B) a flexible material comprising 50 to 100% by weight of hydrophobic fibers and has a maximum absorption capacity of 4 to 15 times its own weight, said sheet substrate is impregnated with 1 to 5 parts by weight, per part by weight of said sheet substrate, of said polishing cleaner, provided that the amount of said polishing cleaner infiltrated in said sheet substrate is not exceed 80% of said maximum absorption capacity, and said polishing cleaner comprises 0.01 to 10% by weight of a water-repellent compound and 50 to 99% by weight of water.

2. A polishing and cleaning sheet according to claim 1, wherein said sheet substrate has a three-layer structure having said flexible material (B) interposed between a pair of said fiber aggregates (A).

3. A polishing and cleaning sheet according to claim 1, wherein said water-repellent compound is an amino-modified silicone emulsion having an average emulsified particle size of 0.01 to 30 μm.

4. A polishing and cleaning sheet according to claim 3, wherein said polishing cleaner contains an organic acid having at least one carboxyl group or a salt thereof and has a pH of 4 to 6.

5. A polishing and cleaning sheet according to claim 1, wherein said polishing cleaner contains a terpene compound.
